(19) United States
(12) Patent Application Publication
(10) Pub. No.: US 2009/0292869 A1
(43) Pub. Date: Nov. 26, 2009

(54) DATA DELIVERY SYSTEMS

(76) Inventors: EDITH HELEN STERN, Yorktown Heights, NY (US); Alan Ganek, Chappaqua, NY (US)

Correspondence Address: HOLLAND & KNIGHT LLP, 10 ST. JAMES AVENUE, BOSTON, MA, 02116, US

(21) Appl. No.: 12/124,285

(22) Filed: May 21, 2008

(51) Int. Cl. G06F 12/00

(52) U.S. Cl. 711/113; 711/E12.001

(57) ABSTRACT

A request for a multi-segment, sequential data file is received from a user. At least a portion of a first segment of the multi-segment, sequential data file is provided from a previously-energized first storage device to the user. A previously-unenergized second storage device that contains a second segment of the multi-segment, sequential data file is energized.

### BACKGROUND OF THE INVENTION

The present invention relates in general to data delivery systems.

Power consumption and cost are ever-increasing problems for data center owners. Accordingly, various methodologies have been utilized to reduce server power consumption. Unfortunately, less focus has been placed on the power consumption of the storage disks accessed by or included within the above-described servers. One such methodology utilized to reduce the power consumption of such disk drives is MAID (i.e., Massive Array of Idle Disks); in which a large group of disk drives is employed. In a MAID system, only those drives in active use are spinning at any given time. While a MAID system reduces power consumption and prolongs the lives of the disk drive, data latency problems may be encountered, as a disk drive will need to be energized prior to the data on the disk drive being accessible.

### BRIEF SUMMARY OF THE INVENTION

In a first implementation, a data-delivery method includes receiving a request for a multi-segment, sequential data file from a user. At least a portion of a first segment of the multi-segment, sequential data file is provided from a previously-energized first storage device to the user. A previously-unenergized second storage device that contains a second segment of the multi-segment, sequential data file is energized.

In another implementation, a computer program product resides on a computer readable medium that has a plurality of instructions stored on it. When executed by a processor, the instructions cause the processor to perform operations including receiving a request for a multi-segment, sequential data file from a user. At least a portion of a first segment of the multi-segment, sequential data file is provided from a previously-energized first storage device to the user. A previously-unenergized second storage device that contains a second segment of the multi-segment, sequential data file is energized.

In another implementation, a computing system includes at least one processor and at least one memory architecture coupled with the at least one processor. A first software module is executed on the at least one processor and the at least one memory architecture. The first software module is configured to receive a request for a multi-segment, sequential data file from a user. A second software module is executed on the at least one processor and the at least one memory architecture. The second software module is configured to provide at least a portion of a first segment of the multi-segment, sequential data file from a previously-energized first storage device to the user. A third software module is executed on the at least one processor and the at least one memory architecture. The third software module is configured to energize a previously-unenergized second storage device that contains a second segment of the multi-segment, sequential data file.

### BRIEF DESCRIPTION OF THE SEVERAL VIEWS OF THE DRAWINGS

FIG. 1 is a diagrammatic view of a data delivery process coupled to a distributed computing network;

FIG. 2 is a diagrammatic view of a plurality of disk drives controllable by the data delivery process of FIG. 1; and

FIG. 3 is a flowchart of the data delivery process of FIG. 1.

Like reference symbols in the various drawings indicate like elements.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

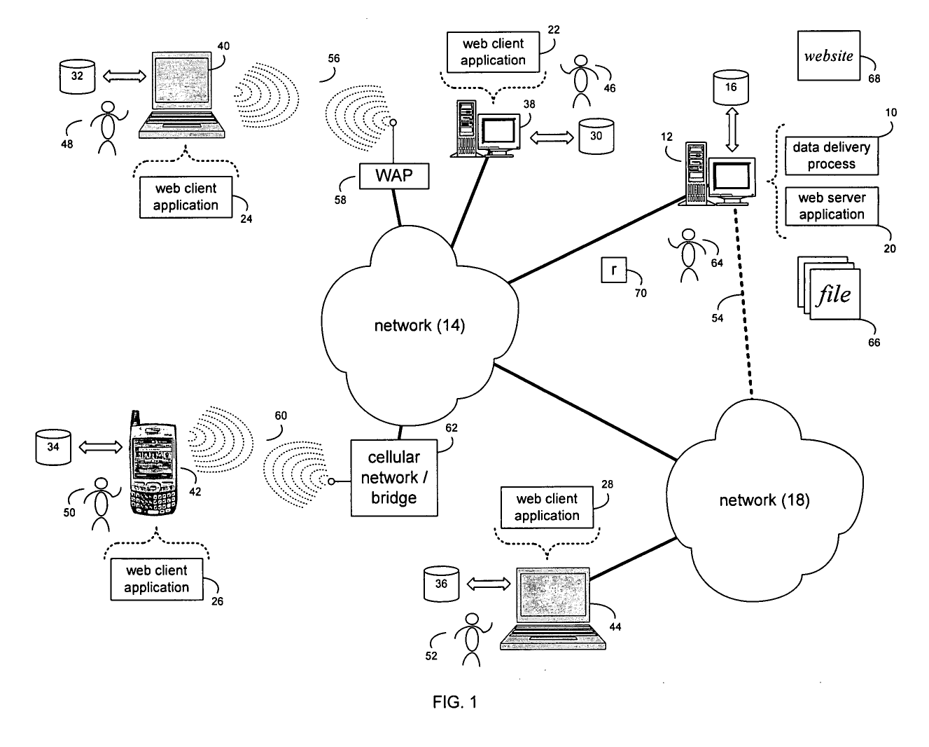

Referring to FIG. 1, there is shown data delivery process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® XP Server; Novell® Netware®; or Red Hat® Linux® operating systems. Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvales in the United States, other countries or both.

As will be discussed below in greater detail, data delivery process 10 may receive a request for a multi-segment, sequential data file from a user. At least a portion of a first segment of the multi-segment, sequential data file may be provided from a previously-energized first storage device to the user. A previously-unenergized second storage device that contains a second segment of the multi-segment, sequential data file may be energized.

The instruction sets and subroutines of data delivery process 10, which may be configured as one or more software modules and may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute web server application 20, examples of which may include but are not limited to: Microsoft IIS, Novell Webserver™, or Apache® Webserver, that allows for e.g., HTTP (i.e., HyperText Transfer Protocol) access to server computer 12 via network 14. Webserver is a trademark of Novell Corporation in the United States, other countries or both; and Apache is a registered trademark of Apache Software Foundation in the United States, other countries or both. The instruction sets and subroutines of web server application 20, which may be stored on storage device 16 coupled to server computer 12, may be executed by one or more processors (not shown) and one or more memory architectures (not shown) incorporated into server computer 12.

Network 14 may be connected to one or more secondary networks (e.g., network 18), examples of which may include but are not limited to: a local area network; a wide area network; or an intranet, for example. Data delivery process 10 may be a stand alone application that interfaces with web server application 20 or an applet/application that is executed within web server application 20.

The instruction sets and subroutines of web client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of web client applications 22, 24, 26, 28 may include Microsoft Internet Explorer®, Apple® Safari™, and Mozilla® FireFox® browsers. Internet Explorer is a registered trademark of Microsoft Corporation in the United States, other countries or both; Apple and Safari trademarks of Apple Inc. in the United States, other countries or both; Mozilla and Firefox are registered trademarks of Mozilla Foundation in the United States, other countries or both.

Examples of computing devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using web client applications 22, 24, 26, 28, users 46, 48, 50, 52 may access one or more applications resident on and served by e.g., server computer 12 and/or web server application 20 and effectuate the transfer of one or more data files (e.g., an application file, an audio file, a video file, and an audio-video file) from server computer 12 to one or more of computing devices 38, 40, 42, 44.

Users 46, 48, 50, 52 may access web server application 20 directly through the device on which the web client application (e.g., web client applications 22, 24, 26, 28) is executed, namely client electronic devices 38, 40, 42, 44, for example. Users 46, 48, 50, 52 may access web server application 20 directly through network 14 or through secondary network 18. Further, server computer 12 (i.e., the computer that executes web server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows®, Microsoft Windows CE, Red Hat Linux operating systems, or a custom operating system.

For the following discussion, web client application 22 is going to be described for illustrative purposes. However, this is not intended to be a limitation of this disclosure, as other web client applications (e.g., web client applications 24, 26, 28) may be equally utilized.

As discussed above, data delivery process 10 may receive a request for a multi-segment, sequential data file from a user. At least a portion of a first segment of the multi-segment, sequential data file may be provided from a previously-energized first storage device to the user. A previously-unenergized second storage device that contains a second segment of the multi-segment, sequential data file may be energized.

Administrator 64 of data delivery process 10 may utilize data delivery process 10 to provide one or more of multi-segment sequential data files 66 (e.g., an application file, an audio file, a video file, and an audio-video file) from server computer 12 (e.g., a media server) to one or more of client electronic devices 38, 40, 42, 44.

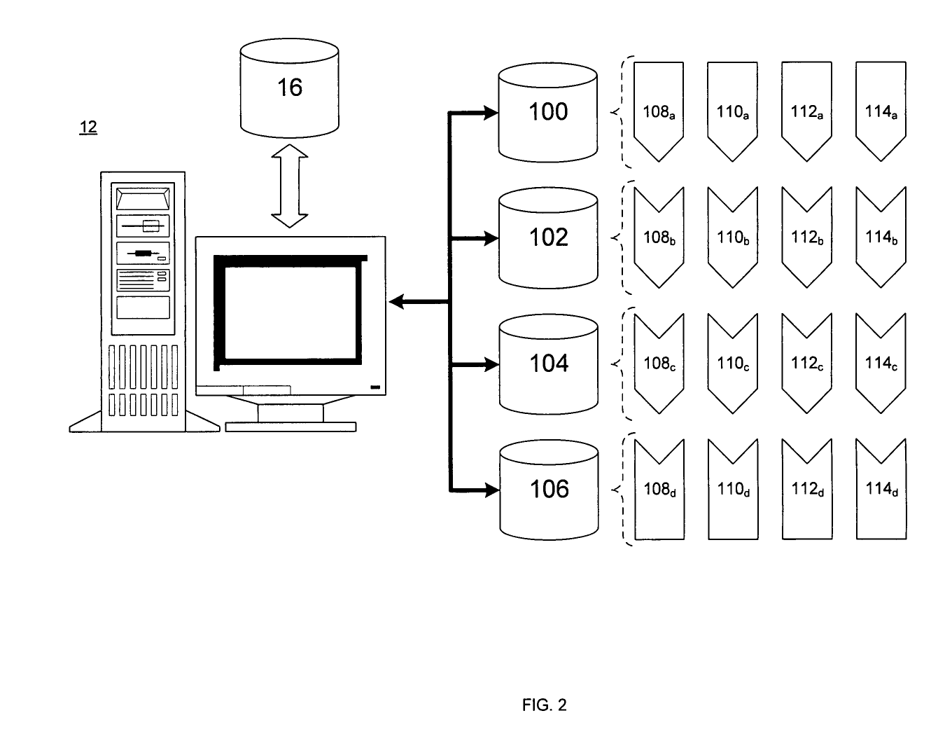

Referring also to FIG. 2, assume for illustrative purposes that user 46 of personal computer 38 accesses website 68 to view one or more of multi-segment sequential data files 66. An example of website 68 may include but is not limited to a website that allows for the streaming of video files (e.g. www.youtube.com), a website that allows for the streaming of audio files (e.g. www.rhapsody.com), or a website that distributes software applications (e.g. www.downloads.com).

Assume for illustrative purposes that website 68 is a video streaming website and further assume for illustrative purposes that when reviewing the available multi-segment sequential data files available for downloading, a user may watch the first few seconds of a file to determine if it is the file that they wish to watch in its entirety. In the event that the user is not interested in the file, the user may cancel the stream of the selected file and may select a different file (chosen from the group of multi-segment sequential data files 66) for viewing. Accordingly, a situation may occur in which the user of data delivery process 10 may watch the beginning of a plurality of multi-segment, sequential data files prior to watching a specific multi-segment, sequential data file in its entirety.

Accordingly, in the interest of reducing power consumption with respect to server computer 12, the various multi-segment, sequential data files 66 may be distributed across a plurality of disk drives (e.g. disk drives 100, 102, 104, 106) coupled to server computer 12. For illustrative purposes only, assume that multi-segment, sequential data files 66 includes four specific data files (e.g. data files 108, 110, 112, 114), each of which is representative of a feature-length video available for online viewing by user 46 via e.g. web client application 22 executed by personal computer 38.

Further, assume for illustrative purposes that administrator 64 of data delivery process 10 has segmented each of multi-segment, sequential data files 108, 110, 112, 114 into four segments. Accordingly, multi-segment, sequential data file 108 may be segmented into segments 108ₐ, 108_{b}, 108_{c}, 108_{d}); multi-segment, sequential data file 110 may be segmented into segments 110ₐ, 110_{b}, 110_{c}, 110_{d}); multi-segment, sequential data file 112 may be segmented into segments 112ₐ, 112_{b}, 112_{c}, 112_{d}); and multi-segment, sequential data file 114 may be segmented into segments 114ₐ, 114_{b}, 114_{c}, 114_{d}). Further, assume for illustrative purposes that segments 108ₐ, 110ₐ, 112ₐ, 114ₐ each represent the beginning portion of the corresponding multi-segment, sequential file (i.e., multi-segment, sequential data files 108, 110, 112, 114 respectively). Accordingly, segments 108ₐ, 110ₐ, 112ₐ, 114ₐ may represent the initial ten minutes of a feature-length film.

When configuring server computer 12, disk drives 100, 102, 104, 106 may be configured so that disk drive 100 (i.e. the disk drive that stores segments 108ₐ, 110ₐ, 112ₐ, 114ₐ representative of the initial ten minutes of each of the four feature-length films) may be always energized (e.g. disk drive 100 may always be spinning). Conversely, the remaining disk drives (e.g., disk drives 102, 104, 106) may be configured so that they are only energized when the segments stored on these disk drives need to be provided to a user. Accordingly, in the event that user 46 views the first ten of each of multi-segment, sequential data files 108, 110, 112 prior to viewing multi-segment, sequential data file 114 in its entirety, disk drives 102, 104, 106 may not be energized until after segments 108ₐ, 110ₐ, 112ₐ, 114ₐ are viewed in their entirety. Accordingly and in this example, during the forty minutes required for user 46 to view segments 108ₐ, 110ₐ, 112ₐ, 114ₐ, disk drives 102, 104, 106 may remain unenergized (e.g., disk drives 102, 104, 106 may not be spinning). Accordingly, through the use of data delivery process 10, energy savings may be realized with respect to server computer 12.

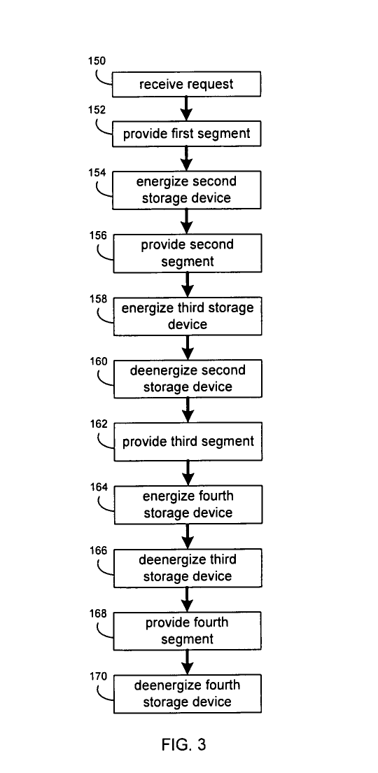

Referring also to FIG. 3 and continuing with the above-stated example, data delivery process 10 may receive 150 a request (e.g. request 70) for multi-segment, sequential data file (e.g. multi-segment, sequential data file 114) from user 46. As discussed above, request 70 may be received after user 46 viewed the first ten minutes of each of multi-segment sequential data files 108, 110, 112 (namely after user 46 viewed segments 108ₐ, 110ₐ, 112ₐ).

Accordingly, upon data delivery process 10 receiving 150 request 70 for multi-segment, sequential data file 114, data delivery process 10 may provide 152 at least a portion of a first segment (e.g., segment 114ₐ) of a multi-segment, sequential data file (e.g., multi-segment, sequential data file 114) from a previously-energized first storage device (e.g. disk drive 100) to user 46. As discussed above, disk drive 100 may be configured to contain the initial segments of each of multi-segment, sequential data files 108, 110, 112, 114. As also discussed above, disk drive 100 may be continuously energized to allow the initial segments of each of multi-segment, sequential data files 108, 110, 112, 114 to be provided to e.g. user 46 in a comparatively speedy fashion. Further and as discussed above, disk drives 102, 104, 106 may remain unenergized until a user wishes to view a segments stored within one of these disk drives.

Assume for illustrative purposes that user 46 views segment 114ₐ in its entirety. Accordingly, at some point prior to user 46 completing their viewing of segment 114ₐ data delivery process 10 may energize 154 a previously-unenergized second storage device (e.g., disk drive 102) that contains a second segment (e.g., segment 114_{b}) of multi-segment, sequential data file 114. For example, assume for illustrative purposes that when fully unenergized, it takes ten seconds for data delivery process 10 to energize 154 disk drive 102. Accordingly, at some point in time at least ten seconds prior to data delivery process 10 completely providing 152 segment 114a to user 46, data delivery process 10 may energize 154 disk drive 102 so that disk drive 102 is available to provide the second data segment (e.g., segment 114_{b}) once segment 114ₐ has been completely provided 152 to user 46.

Accordingly and once disk drive 102 is energized 154, data delivery process 10 may provide 156 at least a portion of the second segment (e.g., segment 114_{b}) in multi-segment, sequential data file 114 from the previously-unenergized second storage device (e.g., disk drive 102) to user 46. Assume for illustrative purposes that segment 114_{b} of multi-segment, sequential data file 114 is thirty minutes long. Accordingly, for at least the next thirty minutes, disk drive 102 may remain energized so that the second segment (e.g., segment 114_{b}) of multi-segment, sequential data file 114 may be provided 156 to user 46.

Assume for illustrative purposes that user 46 views segment 114_{b} in its entirety. Accordingly, at some point prior to user 46 completing their viewing of segment 114_{b}, data delivery process 10 may energize 158 a previously-unenergized third storage device (e.g., disk drive 104) that contains a third segment (e.g., segment 114_{c}) of multi-segment, sequential data file 114. Again, assume for illustrative purposes that when fully unenergized, it takes ten seconds for data delivery process 10 to energize 158 disk drive 104. Accordingly, at some point in time at least ten seconds prior to data delivery process 10 completely providing 156 segment 114_{b} to user 46, data delivery process 10 may energize 158 disk drive 104 so that disk drive 104 is available to provide the third data segment (e.g., segment 114_{c}) once segment 114_{b} has been completely provided 156 to user 46.

Data delivery process 10 may deenergize 160 the second storage device (e.g., disk drive 102) after the second segment (e.g., segment 114_{b}) of multi-segment, sequential data file 114 has been at least substantially provided 156 to user 46. For example, assume for illustrative purposes that when reading data (e.g., segment 114_{b}) from disk drive 102, the data read is placed into a cache memory system (not shown) for being subsequently provided 156 to user 46. Accordingly, once all of segment 114_{b} is retrieved from disk drive 102 and placed into the above-describe cache memory system (not shown), disk drive 102 may be deenergized 160. Alternatively, in the event that the above-described cache memory system (not shown) is not used, data delivery process 10 may only deenergize 160 disk drive 102 after segment 114_{b} has been completely provided 156 to user 46.

Accordingly and once disk drive 104 is energized 158, data delivery process 10 may provide 162 at least a portion of the third segment (e.g., segment 114_{c}) in multi-segment, sequential data file 114 from the previously-unenergized third storage device (e.g., disk drive 104) to user 46. Assume for illustrative purposes that segment 114_{c} of multi-segment, sequential data file 114 is also thirty minutes long. Accordingly, for at least the next thirty minutes, disk drive 104 may remain energized so that the third segment (e.g., segment 114_{c}) of multi-segment, sequential data file 114 may be provided 162 to user 46.

Assume for illustrative purposes that user 46 views segment 114_{c} in its entirety. Accordingly, at some point prior to user 46 completing their viewing of segment 114_{c}, data delivery process 10 may energize 164 a previously-unenergized fourth storage device (e.g., disk drive 106) that contains a fourth segment (e.g., segment 114_{d}) of multi-segment, sequential data file 114. Again, assume for illustrative purposes that when fully unenergized, it takes ten seconds for data delivery process 10 to energize 164 disk drive 106. Accordingly, at some point in time at least ten seconds prior to data delivery process 10 completely providing 162 segment 114_{c} to user 46, data delivery process 10 may energize 164 disk drive 106 so that disk drive 106 is available to provide the fourth data segment (e.g., segment 114_{d}) once segment 114_{c} has been completely provided 162 to user 46.

Data delivery process 10 may deenergize 166 the third storage device (e.g., disk drive 104) after the third segment (e.g., segment 114_{c}) of multi-segment, sequential data file 114 has been at least substantially provided 162 to user 46. Again, assume for illustrative purposes that when reading data (e.g., segment 114_{c}) from disk drive 104, the data read is placed into a cache memory system (not shown) for being subsequently provided 162 to user 46. Accordingly, once all of segment 114_{c} is retrieved from disk drive 104 and placed into the above-describe cache memory system (not shown), disk drive 104 may be deenergized 166. Alternatively, in the event that the above-described cache memory system (not shown) is not used, data delivery process 10 may only deenergize 166 disk drive 104 after segment 114_{c} has been completely provided 162 to user 46.

Accordingly and once disk drive 106 is energized 164, data delivery process 10 may provide 168 at least a portion of the fourth segment (e.g., segment 114_{d}) in multi-segment, sequential data file 114 from the previously-unenergized fourth storage device (e.g., disk drive 106) to user 46. Assume for illustrative purposes that segment 114_{d} of multi-segment, sequential data file 114 is also thirty minutes long. Accordingly, for at least the next thirty minutes, disk drive 106 may remain energized so that the fourth segment (e.g., segment 114_{d}) of multi-segment, sequential data file 114 may be provided 168 to user 46.

Again, data delivery process 10 may deenergize 170 the fourth storage device (e.g., disk drive 106) after the fourth segment (e.g., segment 114_{d}) of multi-segment, sequential data file 114 has been at least substantially provided 168 to user 46. Again, assume for illustrative purposes that when reading data (e.g., segment 114_{d}) from disk drive 106, the data read is placed into a cache memory system (not shown) for being subsequently provided 168 to user 46. Accordingly, once all of segment 114_{d} is retrieved from disk drive 106 and placed into the above-describe cache memory system (not shown), disk drive 106 may be deenergized 170. Alternatively, in the event that the above-described cache memory system (not shown) is not used, data delivery process 10 may only deenergize 170 disk drive 106 after segment 114_{d} has been completely provided 168 to user 46.

While data delivery process 10 and webserver application 20 are described above as being executed on a single computer (i.e., server computer 12), this is for illustrative purposes only, as other configurations are possible. For example, data delivery process 10 and webserver application 20 may each be executed on separate computers.

While data delivery process 10 is described above as controlling four disk drives, this is four illustrative purposes only, as other configurations are possible. For example, the total number of disk drives controllable by data delivery process 10 may be increased or decreased based upon specific need and design criteria.

While each of data files 108, 110, 112, 114 are described above as being segmented into four segments, this is four illustrative purposes only, as other configurations are possible. For example, the total number of segments that each of data files 108, 110, 112, 114 is broken into may be increased or decreased based upon specific need and design criteria.

As discussed above, data delivery process 10 may energize 154, 158, 164 and may deenergize 160, 166, 170 disk drives 102, 104, 106 (respectively), which may be effectuated by data delivery process 10 in a variety ways (all of which are considered to be within the scope of this disclosure). For example, data delivery process 10 may send an energize/deenergize signal to the particular disk to be energized/deenergized. Alternatively, data delivery process 10 may send an energize/deenergize signal to the power supply so that the power supply can supply power to (or cut power from) the disk drive to be energized/deenergized. Further still, data delivery process 10 may send an energize/deenergize signal to a relay that is inline with the power cable providing power to the disk drive to be energized/deenergized.

While data delivery process 10 is described above as being executed on a server computer (e.g., server computer 12) which is executing a web server application (e.g., web server application 20) that is accessible by one or more web clients (e.g., web clients 22, 24, 26, 28), this is for illustrative purposes only and is not intended to be a limitation of this disclosure, as other configurations are possible. Specifically, data delivery process 10 may be a non-web-based application that is executed on server computer 12. For example, data delivery process 10 may be executed on an in-house enterprise desktop computer that is coupled (via an enterprise network) to a tiered storage system. Further, data delivery process 10 may not communicate via web protocols. Additionally, the client applications may be a custom application (as opposed to a web browser) and may not be a web client and may communicate through the use of e.g., a custom protocol.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A data-delivery method comprising:
receiving a request for a multi-segment, sequential data file from a user;
providing at least a portion of a first segment of the multi-segment, sequential data file from a previously-energized first storage device to the user; and
energizing a previously-unenergized second storage device that contains a second segment of the multi-segment, sequential data file.

2. The data-delivery method of claim 1 wherein the previously-energized first storage device is a hard disk drive.

3. The data-delivery method of claim 1 wherein the previously-unenergized second storage device is a hard disk drive.

4. The data-delivery method of claim 1 further comprising:
providing at least a portion of the second segment of the multi-segment, sequential data file from the previously-unenergized second storage device to the user.

5. The data-delivery method of claim 4 further comprising:
deenergizing the second storage device after the second segment of the multi-segment, sequential data file has been at least substantially provided to the user.

6. The data-delivery method of claim 4 further comprising:
energizing a previously-unenergized third storage device that contains a third segment of the multi-segment, sequential data file.

7. The data-delivery method of claim 6 wherein the previously-unenergized third storage device is a hard disk drive.

8. The data-delivery method of claim 6 further comprising:
providing at least a portion of the third segment of the multi-segment, sequential data file from the previously-unenergized third storage device to the user.

9. The data-delivery method of claim 8 further comprising:
deenergizing the third storage device after the third segment of the multi-segment, sequential data file has been at least substantially provided to the user.

10. The data-delivery method of claim 1 wherein the multi-segment, sequential data file comprises at least one of an application file, an audio file, a video file, and an audio-video file.

11. A computer program product residing on a computer readable medium having a plurality of instructions stored thereon, which, when executed by a processor, cause the processor to perform operations comprising:
receiving a request for a multi-segment, sequential data file from a user;
providing at least a portion of a first segment of the multi-segment, sequential data file from a previously-energized first storage device to the user; and
energizing a previously-unenergized second storage device that contains a second segment of the multi-segment, sequential data file.

12. The computer program product of claim 11 wherein the previously-energized first storage device is a hard disk drive.

13. The computer program product of claim 11 wherein the previously-unenergized second storage device is a hard disk drive.

14. The computer program product of claim 11 further comprising instructions for:
providing at least a portion of the second segment of the multi-segment, sequential data file from the previously-unenergized second storage device to the user.

15. The computer program product of claim 14 further comprising instructions for:
deenergizing the second storage device after the second segment of the multi-segment, sequential data file has been at least substantially provided to the user.

16. A computing system comprising:
at least one processor;
at least one memory architecture coupled with the at least one processor;
a first software module executed on the at least one processor and the at least one memory architecture, wherein the first software module is configured to receive a request for a multi-segment, sequential data file from a user;
a second software module executed on the at least one processor and the at least one memory architecture, wherein the second software module is configured to provide at least a portion of a first segment of the multi-segment, sequential data file from a previously-energized first storage device to the user; and
a third software module executed on the at least one processor and the at least one memory architecture, wherein the third software module is configured to energize a previously-unenergized second storage device that contains a second segment of the multi-segment, sequential data file.

17. The computing system of claim 16 wherein the previously-energized first storage device is a hard disk drive.

18. The computing system of claim 16 wherein the previously-unenergized second storage device is a hard disk drive.

19. The computing system of claim 16 wherein the second software module is further configured to provide at least a portion of the second segment of the multi-segment, sequential data file from the previously-unenergized second storage device to the user.

20. The computing system of claim 19 wherein at least one of the software modules is further configured to deenergize the second storage device after the second segment of the multi-segment, sequential data file has been at least substantially provided to the user.
